(19) United States
(12) Patent Application Publication
(10) Pub. No.: US 2008/0090010 A1
(43) Pub. Date: Apr. 17, 2008

(54) Hydrophobic Coating Composition

(75) Inventors: Hua Zhang, New South Wales (AU); Robert Norman Lamb, New South Wales (AU)

Correspondence Address: FITCH EVEN TABIN AND FLANNERY, 120 SOUTH LA SALLE STREET, SUITE 1600, CHICAGO, IL, 60603-3406, US

(73) Assignee: NewSouth Innovations Pty Limited, Sydney, NSW (AU)

(21) Appl. No.: 10/586,073

(22) PCT Filed: Jan. 14, 2005
(86) PCT No.: PCT/AU05/00043

§ 371 Date: Jul. 14, 2006

(30) Foreign Application Priority Data
Jan. 15, 2004 (AU) 2004900175

(51) Int. Cl. C09D 5/00; B05D 3/00

(52) U.S. Cl. 427/372.2; 106/287.14; 106/287.35; 524/588

(57) ABSTRACT

A hydrophobic coating composition comprising: (a) nanoparticles or precursors capable of forming nanoparticles; (b) microparicles; and (c) an organic solvent. The coating composition can be applied to a surface of a substrate to form a hydrophobic coating having both microscale and nanoscale roughness.

### TECHNICAL FIELD

The present invention relates generally to hydrophobic coating compositions which can be applied to a surface (such as bricks, cement, concrete, mortar and plaster) to form a hydrophobic coating on the surface.

### BACKGROUND ART

The contact angle θ made by a droplet of liquid on a surface of a solid substrate is used as a quantitative measure of the wettability of the surface. If the liquid spreads completely across the surface and forms a film, the contact angle θ is 0°. If there is any degree of beading of the liquid on the surface, the surface is considered to be non-wetting.

If the surface is rough or heterogeneous there are usually two contact angles that can be measured. Tilting the substrate until the droplet is about to roll off illustrates this phenomena. The leading edge of the droplet represents the largest measurable contact angle (called the advancing angle or θ_{adv}), while the receding edge or tail measurement is the minimum contact angle measurable (called the receding angle or θ_{rec}). The difference between the advancing and receding contact angles is known as the contact angle hysteresis and defines the degree of dynamic wettability.

For water, a surface is usually considered to be hydrophobic if the contact angle is greater than 90°. Coatings having water contact angles greater than 90° are commonly referred to as hydrophobic coatings. Surfaces with water contact angles greater than 130°, are commonly referred to as “superhydrophobic”. Similarly, coatings having water contact angles greater than 130° are commonly referred to as superhydrophobic coatings (SHC).

Hydrophobic surfaces have little or no tendency to absorb water, and water forms a discrete droplet on the surface. Hydrophobic materials possess low surface energy values and lack active groups in their surface chemistry for forming “hydrogen-bonds” with water. An example of a hydrophobic surface is a polytetrafluoroethylene (Teflon™) surface. Water contact angles on a polytetrafluoroethylene surface can reach about 115°. This is about the upper limit of hydrophobicity on smooth surfaces.

Superhydrophobic surfaces have been the subject of increased interest due to their wide range of applications and unique properties.

Superhydrophobic coatings have very high water repellency. On these coatings, water appears to form spherical beads that roll off the coating at small inclination.

Superhydrophobic coatings display a “self cleaning” property, in which dirt or spores, bacteria, or other microorganisms that come into contact with the surface are unable to adhere to the coating and are readily washed away with water. Further, the extreme water repellency of such coatings gives the surface anti-fouling, anti-icing and anti-corrosion properties.

Typically, superhydrophobic surfaces have been produced by multi-layer techniques, e.g. the formation of a first layer of surface roughness followed by chemical treatment with a fluorinated surface modifier. Such surfaces can produce contact angles up to 170°. However, fluorinated derivatives are expensive.

In view of the wide range of applications of hydrophobic coatings, it would be advantageous to provide alternative hydrophobic coating compositions which can be used to form hydrophobic coatings on surfaces.

### SUMMARY OF THE INVENTION

In a first aspect, the present invention provides a hydrophobic coating composition comprising:

(a) nanoparticles or precursors capable of forming nanoparticles;

(b) microparticles; and

(c) an organic solvent;

whereby, on application of the coating composition to a surface of a substrate and then curing, a hydrophobic coating having both microscale and nanoscale roughness is formed on the surface.

In some embodiments of the first aspect of the present invention, the nanoparticles are provided by a sol solution prepared by the hydrolysis and condensation of one or more compounds of the formula (A):

R¹M(OR)₃ (A)

wherein:
R¹ is a non-polar group,
M is a metal, and
each R is independently selected and is an alkyl group,
optionally together with one or more additional compounds selected from the group consisting of compounds of the formula (B) and compounds of the formula (C):

M(OR)ₙ (B)

wherein:
M is a metal,
each R is independently selected and is an alkyl group, and
n is 3 or 4;

R¹M(OR)ₘ (C)

wherein:
R¹ is a non-polar group,
M is a metal,
each R is independently selected and is an alkyl group, and
m is 1 or 2.

In formulas (A), (B) and (C), R is typically a C₁₋₁₀ alkyl, such as methyl, ethyl, propyl, etc.

In formula (A), M is typically Si or Zn, more typically Si. In formula (B), M is typically Si, Zn or Al. In formula (C), M may for example be Al or Zn. Compounds of formula (C) include, for example, compounds of the formula R¹Al(OR)₂ or R¹Zn(OR).

In formulas (A) and (C), R¹ may be any non-polar group. R¹ is typically C₁₋₁₀ alkyl, C₂₋₁₀ alkenyl, phenyl, an epoxy group, an acrylate group or an isocyanate group. When R¹ is an alkyl, alkenyl or phenyl group, the alkyl, alkenyl or phenyl group may be optionally substituted by one or more non-polar groups.

The compound of formula (B) may for example be a tetraalkoxysilane, such as tetraethyl orthosilicate (Si(OCH₂CH₃)₄) or tetramethyl orthosilicate (Si(OCH₃)₄).

The hydrolysis and condensation of the one or more compounds of the formula (A), optionally together with one or more additional compounds selected from the group consisting of compounds of the formula (B) and compounds of the formula (C), forms hydrophobic covalently-linked networks. These networks form hydrophobic particles. These hydrophobic particles are nanoparticles or capable of reacting with further compounds of the formula (A), (B) or (C) to form hydrophobic nanoparticles.

In some embodiments, the nanoparticles are provided by a sol solution prepared by the hydrolysis and condensation of one or more tri-functionalised alkylsilanes.

In some embodiments, the precursors capable of forming nanoparticles are one or more compounds of the formula (A) optionally together with compounds of the formula (B) or (C). In such embodiments, during the curing of the coating composition, the compounds of formula (A) (and optionally compounds of formulas (B) and (C)) react together in a modified sol-gel reaction to form hydrophobic nanoparticles.

In some embodiments, the precursors capable of forming nanoparticles are one or more tri-functionalised alkylsilanes. In such embodiments, during the curing of the coating composition, the one or more tri-functionalised alkylsilanes react together in a modified sol-gel reaction to form hydrophobic nanoparticles.

In a second aspect, the present invention provides a hydrophobic coating composition comprising a mixture of:

(a) a sol solution prepared by the hydrolysis and condensation of a tri-functionalised alkylsilane;

(b) microparticles; and

(c) an organic solvent;

whereby, on application of the coating composition to a surface of a substrate and then curing, a hydrophobic coating having both microscale and nanoscale roughness is formed on the surface.

In some embodiments of the second aspect of the present invention, the sol solution is prepared by mixing:

(a) a tri-functionalised alkylsilane,

(b) a catalyst for initiating the formation of the sol solution, and

(c) an organic solvent,

under conditions suitable to form the sol solution.

In a third aspect, the present invention provides a hydrophobic coating composition comprising a mixture of:

(a) a tri-functionalised alkylsilane,

(b) a catalyst for initiating the formation of a sol solution,

(c) an organic solvent, and

(d) microparticles,

whereby, on application of the coating composition to a surface of a substrate and then curing, a hydrophobic coating having both microscale and nanoscale roughness is formed on the surface.

In a fourth aspect, the present invention provides a method of preparing a hydrophobic coating composition, the method comprising mixing nanoparticles, or precursors capable of forming nanoparticles, with microparticles and an organic solvent to form the hydrophobic coating composition as a slurry, wherein, on application of the coating composition to a surface of a substrate and then curing, a hydrophobic coating having both microscale and nanoscale roughness is formed on the surface.

In some embodiments of the fourth aspect of the present invention, the nanoparticles are provided by a sol solution prepared by the hydrolysis and condensation of the one or more compounds of the formula (A), optionally together with one or more additional compounds selected from the group consisting of compounds of the formula (B) and compounds of the formula (C), wherein the compounds of the formula (A), (B) and (C) are as described above.

In some embodiments, the nanoparticles are provided by a sol solution prepared by the hydrolysis and condensation of a tri-functionalised alkylsilane.

In a fifth aspect, the present invention provides a method of preparing a hydrophobic coating composition, the method comprising:

(a) preparing a sol solution by the hydrolysis and condensation of a tri-functionalised alkylsilane;

(b) mixing the resultant sol solution with microparticles and an organic solvent;

thereby forming the coating composition in the form of a slurry.

In some embodiments of the fifth aspect of the present invention, the sol solution is prepared by mixing:

(a) a tri-functionalised alkylsilane,

(b) a catalyst for initiating the formation of the sol solution, and

(c) an organic solvent,

under conditions suitable to form the sol solution.

In a sixth aspect, the present invention provides a method of preparing a hydrophobic coating composition, the method comprising mixing:

(a) a tri-functionalised alkylsilane,

(b) a catalyst for initiating the formation of a sol solution,

(c) an organic solvent, and

(d) microparticles;

thereby forming the coating composition in the form of a slurry.

In a seventh aspect, the present invention provides a hydrophobic coating composition prepared by the method according to the fourth, fifth or sixth aspect of the present invention.

In an eighth aspect, the present invention provides a method of forming a hydrophobic coating on a surface of a substrate, the method comprising the steps of:

(I) applying a hydrophobic coating composition according to the first, second, third or seventh aspect of the present invention to the surface of the substrate; and then

(II) curing the applied coating composition to form a hydrophobic coating on the surface.

In a ninth aspect, the present invention provides an article having a surface on which a hydrophobic coating has been formed by the method of the eighth aspect of the present invention.

The present inventors have found that the coating composition of present invention can be used to produce a hydrophobic coating as a one step process. The coatings formed by the coating composition of the present invention have both microscale and nanoscale roughness. The combination of microscale and nanoscale roughness contributes to the hydrophobicity of the coating.

### DETAILED DESCRIPTION OF THE PREFERRED EMBODIMENTS

Embodiments of the present invention will now be described in further detail.

There are two major factors which determine the degree of hydrophobicity of a surface: chemical composition and surface roughness. By lowering the surface energy it is possible to increase the hydrophobicity of a surface. An increase in surface roughness directly results in an increase in hydrophobicity.

When a coating composition of the present invention is applied to a surface and cured, a coating is formed comprising nanoparticles and microparticles such that the coated surface has a roughness in nanoscales and microscales.

The nanoscale and microscale roughness is illustrated in the following schematic representation:

In the schematic representation, the larger particles are the microparticles. The smaller particles are nanoparticles.

A “sol” is defined as solution of colloidal particles.

In a preferred embodiment of the present invention, the coating composition comprises a mixture of a sol solution prepared by the hydrolysis and condensation of a tri-functionalised alkylsilane, microparticles and an organic solvent.

In another preferred embodiment of the present invention, the coating composition comprises a mixture of a tri-functionalised alkylsilane, a catalyst for initiating the formation of a sol solution, an organic solvent, and microparticles. When such a coating composition is exposed to air during the curing process (e.g. on application to a surface), the catalyst initiates the hydrolysis and condensation of the tri-functionalised alkylsilane to form a sol solution.

A sol solution may be prepared by the hydrolysis and condensation of a tri-functionalised alkylsilane. Tri-functionalised alkylsilanes are compounds having a silicon atom bonded to an alkyl group and three functional groups capable of undergoing hydrolysis and condensation reactions. The functional groups may be any group capable of undergoing hydrolysis and condensation. Typically, the tri-functionalised alkylsilane is a trialkoxyalkylsilane.

A sol solution may also be prepared by the hydrolysis and condensation of the one or more compounds of the formula (A), optionally together with one or more additional compounds selected from the group consisting of compounds of the formula (B) and compounds of the formula (C), wherein the compounds of the formula (A), (B) and (C) are as described above.

The hydrolysis and condensation reaction forms hydrophobic covalently-linked networks. These networks form hydrophobic particles. These hydrophobic particles are nanoparticles or capable of reacting with further alkylsilane (or further compounds of the formula (A), (B) or (C)) to form hydrophobic nanoparticles. As the sol solution begins to dry, e.g. during curing, a covalently-linked network of hydrophobic nanoparticles is typically formed.

The hydrolysis and condensation reaction which results in the production of the hydrophobic nanoparticles is a modified sol-gel reaction. Typically, the sol solution is prepared by the hydrolysis and condensation of a tri-functionalised alkylsilane, typically, a trialkoxyalkylsilane of the formula R¹Si(OR)₃ wherein R¹ is an alkyl group, typically a C₁₋₃₀ alkyl, and each R is independently selected and is an alkyl group, typically a C₁₋₃ alkyl. The modified sol-gel reaction is described below by reference to the reaction of a trialkoxyalkylsilane. The modified sol-gel reaction comprises two main reactions which usually occur concurrently:
1. hydrolysis, where an alkoxide group of a trialkoxyalkylsilane is hydrolysed by reaction with water or an alcohol; and
2. condensation, where the hydrolysed alkylsilane reacts with an optionally hydrolysed alkylsilane to form hydrophobic covalently-linked networks.

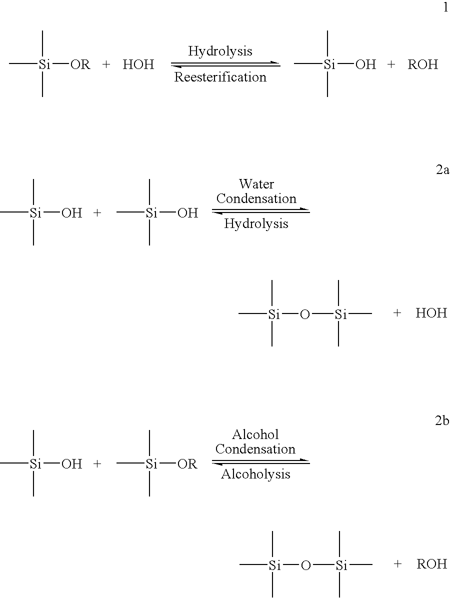

Examples of the covalently-linked networks that may be formed by such reactions include the silsesquioxane or the amorphous polysilsesquioxane, or “ormosil”, shown below. Ormosil is an acronym for organically modified sols.

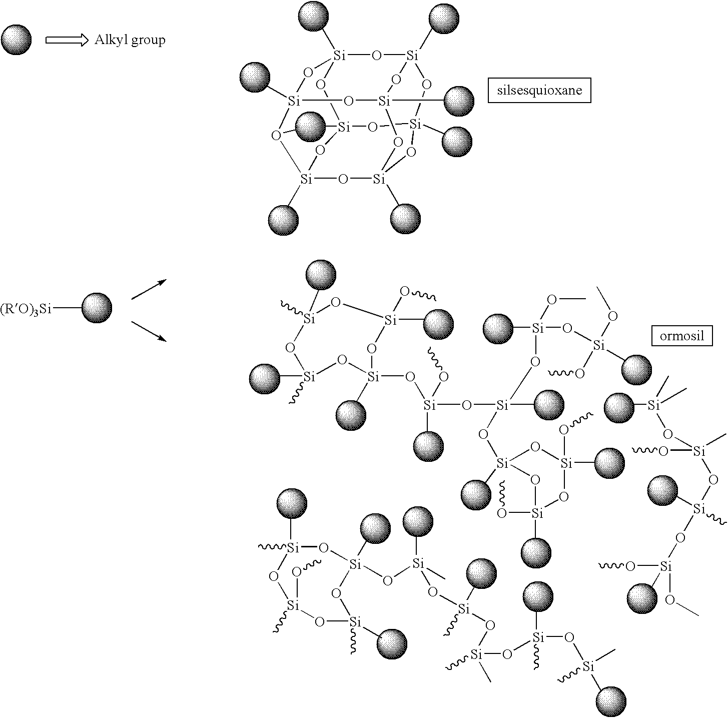

Typically, the sol solution is prepared by mixing one or more tri-functionalised alkylsilanes and a catalyst in an organic solvent. The catalyst initiates the formation of the sol solution, and the organic solvent facilitates dispersion and/or solubilisation of the reactants. The catalyst may be selected from the group consisting of acidified water, alkaline water, a tin catalyst and a zinc catalyst, e.g. dibutyltin dilaurate, tin octoate or zinc octoate. The organic solvent may be selected from the group consisting of an alcohol (e.g. methanol, ethanol, isopropanol and butanol), ethyl acetate, butyl acetate, toluene, hexane, light petroleum, diethylether, methylethylketone, tetrahydrofuran, and xylene. Preferably, the organic solvent is an alcohol.

As mentioned above, in some embodiments of the invention, the coating composition comprises a mixture of a sol solution (which has been prepared by the hydrolysis and condensation of a tri-functionalised alkylsilane), microparticles and an organic solvent. In further embodiments, a di- or tri-functionalised alkylsilane is added to the sol solution before the sol solution is mixed with microparticles. The tri-functionalised alkylsilane may be the same or different to the tri-functionalised alkylsilane used in the formation of the sol solution. The additional di- or tri-functionalised alkylsilane reacts with itself and with the hydrophobic nanoparticles to form a covalently-linked network of hydrophobic nanoparticles during the curing of the coating composition. Further, the di- or tri-functionalised alkylsilane may also react with functional groups on the microparticles and functional groups on the surface to facilitate binding of the hydrophobic nanoparticles to the microparticles and to the surface.

As mentioned above, in other embodiments of the invention, the coating composition comprises a mixture of a tri-functionalised alkylsilane, a catalyst for initiating the formation of a sol solution, an organic solvent, and microparticles. When such a coating composition is exposed to air to begin the curing process (e.g. on application to a surface), the catalyst initiates the hydrolysis and condensation of the tri-functionalised alkylsilane to form a sol solution.

Suitable tri-functionalised alkylsilanes are alkylsilanes having three functional groups and one alkyl group that are capable of undergoing a modified sol-gel reaction. The three functional groups may be the same or different. The functional groups may, for example, be acetoxy, enoxy, oxime, alkoxy and amine. The tri-functionalised alkylsilane may, for example, be selected from the group consisting of trialkoxyalkylsilanes, triacetoxyalkylsilanes, trienoxyalkylsilanes, triaminoalkylsilanes, trioximealkylsilanes and mixtures thereof. In some embodiments, the tri-functionalised alkylsilane is a trialkoxyalkylsilane, e.g. a trialkoxyalkylsilane selected from the group consisting of methyltrimethoxysilane, methyltriethoxysilane, ethyltrimethoxysilane, ethyltriethoxysilane, and mixtures thereof. A mixture of different tri-functionalised alkylsilanes may be used.

The alkyl group on the tri-functionalised alkylsilane may be, for example, methyl, ethyl, propyl, butyl or octyl.

The tri-functionalised alkylsilane may be copolymerised with a hydrophobic polymer. Advantageously, the hydrophobic polymer increases the hydrophobicity of the resultant coating and also enhances the binding of the nanoparticles to each other. The hydrophobic polymer may also react with functional groups on the microparticles (e.g. the hydrophobic polymer may react with hydroxyl groups on the microparticles), and with functional groups present on the surface of the substrate, to enhance the binding of the nanoparticles with the microparticles and the surface. The enhancement in binding results in improved durability and elasticity of the resultant coating.

The hydrophobic polymer may be a hydroxy-terminated polysiloxane. Examples of suitable hydroxy-terminated polysiloxanes include hydroxy-terminated polydimethylsiloxanes (PDMS), hydroxy-terminated polydimethylsiloxane-co-polyphenylmethylsiloxanes, hydroxy-terminated polydiphenylsiloxanes, hydroxy-terminated vinylsiloxane polymers, hydroxy-terminated polyphenylmethylsiloxanes, hydroxy-terminated vinylmethoxysiloxane homopolymers, silanol-terminated polytrifluoropropylmethylsiloxanes, silanol-terminated vinylmethylsiloxane-co-dimethylsiloxanes, and mixtures thereof.

Preferably, the microparticles have surfaces bearing hydroxyl groups. Such hydroxyl groups are able to react with other reactive groups in the various components of the coating composition (such as the hydroxy-terminated polysiloxane) during the curing of the coating composition to strengthen the binding of the microparticles to the nanoparticles and to the surface of the substrate.

Typically, the microparticles are particles of a cementitious material (such as Portland cement and gypsum), an inorganic oxide (which may also be a colorant) or a fibreglass material. Other materials that may be used include clay and fumed silica. Because cementitious materials impart better durability to the coating than many other microparticles, the microparticles are preferably particles of a cementitious material. The inorganic oxide may be particles of any inorganic oxide such as iron oxide red, iron oxide black, iron oxide yellow, iron oxide brown, iron oxide green, titanium(IV) oxide, chromium oxide green, and mixtures thereof.

Any inert volatile organic solvent may be used. For example, the organic solvent may be selected from the group consisting of an alcohol (e.g. methanol, ethanol, isopropanol and butanol), ethyl acetate, butyl acetate, toluene, hexane, light petroleum, diethylether, methylethylketone, tetrahydrofuran, and xylene.

In addition, other additives may be included in the coating composition of the present invention. For example, a colorant, sand or a cementitious material may be added to the coating composition. Colorants (e.g. a pigment or dye) may be added to provide colour to the coating composition. The addition of sand reduces the amount of cement that is required and improves the hardness and strength of the coated surface. Cementitious materials may be added to increase the durability of the coated surface.

The colorant may be any inorganic oxide, such as iron oxide red, iron oxide black, iron oxide yellow, iron oxide brown, iron oxide green, titanium(IV) oxide, chromium oxide green, and mixtures thereof.

Typically, the size of the nanoparticles ranges from about 1 nm to about 200 nm. Preferably, the size of the nanoparticles ranges from about 1 nm to about 50 nm, and more preferably from about 1 nm to about 20 nm.

Typically, the size of the microparticles ranges from about 1 μm to about 100 μm. Preferably, the size of the microparticles ranges from about 1 μm to about 50 μm, and more preferably from about 1 μm to about 20 μm.

In some embodiments, the composition of the present invention comprises the following components in the proportions indicated:

| | Amount |
|---|---|
| Ingredient | (parts per weight) |
| MTMS¹ | 100 |
| PDMS² (hydroxy terminated, 50,000 cst) | 10 |
| Tin catalyst | 0.1-1 |
| Toluene | 100-200 |
| OTES³ | 7-10 |
| 3-Aminopropyltriethoxysilane | 0.2-2 |
| Black pigment (iron oxide) | 5-10 |
| Grey cement | 400-500 |
| Sand | 100-150 |

¹MTMS = methyltrimethoxysilane
²PDMS = polydimethylsiloxane
³OTES = octyltriethoxysilane

When a coating composition of the present invention is applied to a surface and cured, a coating comprising hydrophobic nanoparticles and microparticles is formed, wherein the nanoparticles and microparticles give the coating a roughness in nanoscales and microscales. When the composition comprises, inter alia, a sol solution or reagents to form a sol solution, a covalently-linked network of nanoparticles is formed. Preferably, the hydrophobic nanoparticles are linked to the microparticles and to the surface. The arrangement of the hydrophobic nanoparticles and microparticles in the coating results in the coating having both nanoscale and microscale roughness. Both the hydrophobicity of the nanoparticles, together with the microscale and nanoscale roughness, contributes to the hydrophobicity of the coating.

Tests conducted by the inventors have shown that superhydrophobic surfaces with contact angles greater than 130° and contact angle hysteresis of less than 20° may be produced using such coating compositions.

The hydrophobic coating composition may be prepared by mixing nanoparticles, or precursors capable of forming nanoparticles, and microparticles and an organic solvent to form a slurry. The nanoparticles may be provided by a sol solution as described above.

In one form, the coating composition comprises a mixture of a sol solution prepared by the hydrolysis and condensation of a tri-functionalised alkylsilane, microparticles, and an organic solvent. Such a composition may be prepared by mixing the sol solution, microparticles, and the organic solvent and stirring until the composition is formed as a slurry. Stirring may be carried out at room temperature (e.g. about 15° C. to about 30° C.) or at a suitable elevated temperature (e.g. up to about 80° C.). Alternatively, the mixture may be sonicated in an ultrasonic bath. Typically, the mixture is stirred at room temperature for between about 1 min and about 1 hour, e.g. about 0.5 hour, or sonicated for about 5 min to 10 min at room temperature.

For example, an embodiment of the composition of the present invention may be prepared by mixing methyltrimethoxysilane (MTMS) (100 g), polymethylsiloxane (PDMS) (0-200 g) and ethyl acetate (50-150 mL), and then stirring the mixture for 3 to 6 hours at 60° C. to form a sol solution. The resulting sol solution may be blended with gypsum or cement (having a particle size of about 10 μm to 100 μm) in a ratio of 1:0.2-5 by weight to form a coating composition of the invention as a slurry. The slurry may then be applied to a surface of a substrate and cured. Typically, after curing at room temperature for 24 hours, the resulting surface has a water contact angle greater than 165°.

In another form, the coating composition comprises a mixture of a tri-functionalised alkylsilane, a catalyst for initiating the formation of a sol solution, an organic solvent, and microparticles. Such a composition may be prepared by mixing the tri-functionalised alkylsilane, the catalyst for initiating the formation of a sol solution, the organic solvent, and microparticles and stirring until the composition is formed as a slurry. Stirring may be carried out at room temperature or elevated temperature. Alternatively, the mixture may be sonicated in an ultrasonic bath. Typically, the mixture is stirred at room temperature for between about 1 min and about 1 hour, e.g. about 0.5 hour, or sonicated for about 5 min to 10 min at room temperature.

The composition may be applied to the surface of the substrate by any means known in the art for applying slurries to a surface. The coating composition may, for example, be applied by brushing, dip coating, rolling or spraying.

The composition of the present invention is ideally suited to be applied to substrates such as bricks, cement tiles, wall facades (render) and grout.

Curing may be carried out at room temperature (e.g. about 15° C. to about 30° C.) or at suitable elevated temperatures, e.g. up to about 80° C., in the presence of air. Typically, however, curing is carried out at room temperature. The duration of the curing process is typically between about 12 hours and 48 hours.

During curing, the organic solvent evaporates leaving a coating on the surface comprising nanoparticles and microparticles. A proportion of the nanoparticles are located on the surface of the microparticles thereby forming a coating having a roughness in microscales and nanoscales. If the coating composition comprises precursors capable of forming nanoparticles, then the precursors form the nanoparticles during curing.

When a coating composition comprising a sol solution prepared by the hydrolysis and condensation of a tri-functionalised alkylsilane, microparticles, and an organic solvent is cured, a coating is formed on the surface of the substrate.

When a coating composition of the present invention comprising a mixture of a tri-functionalised alkylsilane, a catalyst for initiating the formation of a sol solution, an organic solvent, and microparticles begins to cure, the catalyst initiates the hydrolysis and condensation of a tri-functionalised alkylsilane to form a sol solution. The hydrolysis and condensation of the tri-functionalised alkylsilane forms hydrophobic covalently-linked networks which form hydrophobic nanoparticles or are capable of reacting with further alkylsilane to form hydrophobic nanoparticles. On curing, the hydrophobic nanoparticles become linked to each other and, typically, also become linked to the microparticles and to the surface of the substrate to form a coating on the surface of the substrate.

When applied to a surface and cured, the coating composition of the present invention produces a hydrophobic coating on the surface. In preferred embodiments of the invention, the water contact angle is greater than 130°, i.e. the coated surface is superhydrophobic. Thus, a water droplet placed on the treated surface easily beads on the surface and rolls off at the slightest vibration. Typically, the contact angle hysteresis is less than 20°.

In more preferred embodiments, the water contact angle is greater than 150°.

In most preferred embodiments, the water contact angle is greater than 160°.

The coating composition of the present invention can be used to form a hydrophobic coating on the surface of a substrate to render the surface water-resistant. Such coatings can be used to reduce or inhibit fouling of the surface by biological organisms, dirt, ice or chemicals.

Preferred embodiments of the invention will now be described, by way of example only, with reference to the following Examples.

### EXAMPLE 1

This example describes an embodiment of the hydrophobic coating composition. The components of the coating composition are set out in Table 1 below by parts per weight.

TABLE 1

| | Amount |
|---|---|
| Ingredient | (parts per weight) |
| MTMS¹ | 100 |
| PDMS² (hydroxy terminated, 50,000 cst) | 10 |
| Tin catalyst³ | 1 |
| Toluene | 200 |
| OTES⁴ | 10 |
| 3-Aminopropyltriethoxysilane | 2 |
| Black pigment (iron oxide) | 10 |
| Grey cement | 500 |
| Sand | 150 |

¹MTMS = methyltrimethoxysilane
²PDMS = polydimethylsiloxane
³Tin catalyst = dibutyltin dilaurate
⁴OTES = octyltriethoxysilane

A mixture of methyltrimethoxysilane (MTMS) (100 g), polymethylsiloxane (PDMS) (10 g), tin catalyst (1 g) and toluene (200 g) was stirred at 60° C. for 3 hours. The resultant sol solution was then blended with octyltriethoxysilane (OTES) (10 g) and 3-aminopropyl-triethoxysilane (2 g). This mixture was then added to a cement/sand/pigment (50/15/10 wt/wt/wt) mixture to form a slurry.

The slurry was applied to a wet concrete surface by brushing, and then cured at 40° C. for 12 hours.

After curing at room temperature for 24 hours, the coated surface showed extreme water resistance and had a water contact angle larger than 165°.

The contact angle was measured on a Ramé-Hart goniometer in conjunction with RHI 2001 Imaging System software. Measurements were reproduced until five concordant results were obtained. All measurements were performed on a dry section of the sample, to negate any chemical changes due to wetting. A sessile drop was used to measure contact angles with the addition and subtraction of water from the drop facilitating the measurement of the advancing and receding contact angles.

### EXAMPLE 2

This example describes three embodiments (A, B and C) of the hydrophobic coating composition. The components of the coating compositions are set out in Table 2.1 below by parts per weight.

TABLE 2.1

| | | B | C |
|---|---|---|---|
| | A | Without | Without |
| | Pigmented | polymer | silica |
| | (parts | (parts | (parts |
| | per | per | per |
| Ingredient | weight) | weight) | weight) |
| Black pigment (iron oxide) | 10 | 10 | 10 |
| Aerosil 200 (fumed silica) | 1 | 1 | 0 |
| OTES¹ | 7-10 | 10-20 | 10-20 |
| MTMS² | 20-25 | 15-22 | 20-25 |
| PDMS³ (hydroxy | 5 | 0 | 5 |
| terminated, 50,000 cst) | | | |
| Tin catalyst⁴ | 0.1-1 | 0.1-1 | 0.1-1 |
| Ethyl acetate | 10-30 | 10-30 | 10-30 |

¹OTES = octyltriethoxysilane
²MTMS = methyltrimethoxysilane
³PDMS = polydimethylsiloxane
⁴Tin catalyst = dibutyltin dilaurate

The components were mixed together and sonicated for about 5 to 10 minutes to the form embodiments A, B and C as a slurry. Each of the resultant slurries was then deposited on the substrate by dip coating and allowed to air dry for about 10 to 30 minutes. The coated substrate was then placed in an oven at 60° C. for about 18 to 24 hours.

The water contact angles of the coated substrates are set out in Table 2.2. The water contact angles were measured as described above in Example 1.

TABLE 2.2

| Embodiment | Water contact angle |
|---|---|
| A Pigmented | 165° |
| B Without polymer | 160° |
| C Without silica | 150° |

Although the invention has been described with reference to particular examples, it will be appreciated by those skilled in the art that numerous variations and/or modifications may be made to the invention as shown in the specific embodiments without departing from the spirit or scope of the invention as broadly described. All such variations and/or modifications are to be considered within the scope of the present invention the nature of which is to be determined from the foregoing description. It will be appreciated by those skilled in the art that the invention may be embodied in many forms. The present embodiments are, therefore, to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-36. (canceled)

37. A hydrophobic coating composition, comprising:
(a) nanoparticles or precursors capable of forming nanoparticles;
(b) microparticles; and
(c) an organic solvent;
whereby, on application of the coating composition to a surface of a substrate and then curing, a hydrophobic coating having both microscale and nanoscale roughness is formed on the surface.

38. A coating composition according to claim 37, wherein the nanoparticles are provided by a sol solution.

39. A coating composition according to claim 38, wherein the sol solution is prepared by hydrolysis and condensation of a tri-functionalized alkylsilane.

40. A coating composition according to claim 39, wherein the sol solution is prepared by mixing:
(a) a tri-functionalized alkylsilane,
(b) a catalyst for initiating formation of the sol solution, and
(c) an organic solvent,
under conditions suitable to form the sol solution.

41. A coating composition according to claim 40, wherein the catalyst is selected from the group consisting of acidified water, alkaline water, tin catalysts and zinc catalysts.

42. A coating composition according to claim 40, wherein the catalyst is selected from the group consisting of dibutyltin dilaurate, tin octoate and zinc octoate.

43. A coating composition according to claim 37, wherein the organic solvent is selected from the group consisting of methanol, ethanol, isopropanol, butanol, ethyl acetate, butyl acetate, toluene, hexane, light petroleum, diethylether, methylethylketone, tetrahydrofuran, and xylene.

44. A coating composition according to claim 39, wherein the tri-functionalized alkylsilane is selected from the group consisting of trialkoxyalkylsilanes, triacetoxyalkylsilanes, trienoxyalkylsilanes, triaminoalkylsilanes, trioximealkylsilanes and mixtures thereof.

45. A coating composition according to claim 44, wherein the tri-functionalized alkylsilane is a trialkoxyalkylsilane selected from the group consisting of methyltrimethoxysilane, methyltriethoxysilane, ethyltrimethoxysilane, ethyltriethoxysilane, and mixtures thereof.

46. A coating composition according to claim 39, wherein the tri-functionalized alkylsilane is copolymerized with a hydrophobic polymer.

47. A coating composition according to claim 46, wherein the hydrophobic polymer is a hydroxy-terminated polysiloxane.

48. A coating composition according to claim 47, wherein the hydroxy-terminated polysiloxane is selected from the group consisting of hydroxy-terminated polydimethylsiloxanes (PDMS), hydroxy-terminated polydimethylsiloxane-co-polyphenylmethylsiloxanes, hydroxy-terminated polydiphenylsiloxanes, hydroxy-terminated vinylsiloxane polymers, hydroxy-terminated polyphenylmethylsiloxanes, hydroxy-terminated vinylmethoxysiloxane homopolymers, silanol-terminated polytrifluoropropylmethylsiloxanes, silanol-terminated vinylmethylsiloxane-co-dimethylsiloxanes, and mixtures thereof.

49. A coating composition according to claim 37, wherein the microparticles are selected from the group consisting of a cementitious material, an inorganic oxide, fibreglass material, clay and fumed silica.

50. A coating composition according to claim 49, wherein the microparticles are microparticles of a cementitious material.

51. A coating composition according to claim 50, wherein the cementitious material is selected from Portland cement and gypsum.

52. A coating composition according to claim 49, wherein the microparticles are microparticles of an inorganic oxide which is selected from the group consisting of iron oxide red, iron oxide black, iron oxide yellow, iron oxide brown, iron oxide green, titanium(IV) oxide, chromium oxide green, and mixtures thereof.

53. A coating composition according to claim 37, further comprising a colorant or a cementitious material.

54. A coating composition according to claim 53, wherein the colorant is particles of an inorganic oxide.

55. A coating composition according to claim 54, wherein the inorganic oxide is selected from the group consisting of iron oxide red, iron oxide black, iron oxide yellow, iron oxide brown, iron oxide green, titanium(IV) oxide, chromium oxide green, and mixtures thereof.

56. A coating composition according to claim 53, wherein the cementitious material is selected from Portland cement and gypsum.

57. A coating composition according to claim 37, wherein the water contact angle on the coating is greater than 130°.

58. A coating composition according to claim 57, wherein the water contact angle on the coating is greater than 150°.

59. A coating composition according to claim 58, wherein the water contact angle on the coating is greater than 160°.

60. A method of preparing a hydrophobic coating composition, the method comprising mixing nanoparticles, or precursors capable of forming nanoparticles, with microparticles and an organic solvent to form the hydrophobic coating composition as a slurry,
wherein, on application of the coating composition to a surface of a substrate and then curing, a hydrophobic coating having both microscale and nanoscale roughness is formed on the surface.

61. A method according to claim 60, wherein the nanoparticles are provided by a sol solution.

62. A method according to claim 61, wherein the sol solution is prepared by hydrolysis and condensation of a tri-functionalized alkylsilane.

63. A method according to claim 62, wherein the sol solution is prepared by mixing:
(a) a tri-functionalized alkylsilane,
(b) a catalyst for initiating the formation of the sol solution, and
(c) an organic solvent,
under conditions suitable to form the sol solution.

64. A method of preparing a hydrophobic coating composition, the method comprising:
(a) preparing a sol solution by hydrolysis and condensation of a tri-functionalized alkylsilane;
(b) mixing the resultant sol solution with microparticles and an organic solvent;
thereby forming the coating composition in the form of a slurry.

65. A method according to claim 64, wherein the sol solution is prepared by mixing:
(a) a tri-functionalized alkylsilane,
(b) a catalyst for initiating the formation of the sol solution, and
(c) an organic solvent,
under conditions suitable to form the sol solution.

66. A method of preparing a hydrophobic coating composition, the method comprising mixing:
(a) a tri-functionalized alkylsilane,
(b) a catalyst for initiating formation of a sol solution,
(c) an organic solvent, and
(d) microparticles;
thereby forming the coating composition in the form of a slurry.

67. A hydrophobic coating composition prepared by the method according to claim 60.

68. A hydrophobic coating composition prepared by the method according to claim 64.

69. A method of forming a hydrophobic coating on a surface of a substrate, the method comprising the steps of: p1 (I) applying a hydrophobic coating composition according to claim 37 to the surface of the substrate; and then
(II) curing the applied coating composition to form a hydrophobic coating on the surface.

70. A method according to claim 69, wherein the coating composition is applied to the surface of the substrate by brushing, dip coating, rolling or spraying.

71. A method according to claim 69, wherein the substrate is selected from the group consisting of brick, cement tiles, wall facades (render) and grout.

72. An article having a surface on which a hydrophobic coating has been formed by the method according to claim 69.

73. A hydrophobic coating composition comprising a mixture of:
(a) a sol solution prepared by hydrolysis and condensation of a tri-functionalized alkylsilane;
(b) microparticles; and
(c) an organic solvent;
whereby, on application of the coating composition to a surface of a substrate and then curing, a hydrophobic coating having both microscale and nanoscale roughness is formed on the surface.

74. A hydrophobic coating composition comprising a mixture of:
(a) a tri-functionalized alkylsilane,
(b) a catalyst for initiating the formation of a sol solution,
(c) an organic solvent, and
(d) microparticles,
whereby, on application of the coating composition to a surface of a substrate and then curing, a hydrophobic coating having both microscale and nanoscale roughness is formed on the surface.
